(19) United States
(12) Patent Application Publication
(10) Pub. No.: US 2004/0258466 A1
(43) Pub. Date: Dec. 23, 2004

(54) Attachment device for attaching a first component to a second component

(76) Inventor: Gunter Hommel, Leonberg (DE)

Correspondence Address: PATENT GROUP, CHOATE, HALL & STEWART, EXCHANGE PLACE, 53 STATE STREET, BOSTON, MA, 02109, US

(21) Appl. No.: 10/003,682

(22) Filed: Nov. 2, 2001

(30) Foreign Application Priority Data
Nov. 2, 2000 (DE) 100 54 205.0

(51) Int. Cl. F16B 5/02

(52) U.S. Cl. 403/261; 403/260; 403/408.1

(57) ABSTRACT

To attach a first component to a second component, a sleeve (10) is inserted in the first component and axially fixed in the first component. A bolt (20) is driven into the sleeve (10) which has a thread (205) on its front end for screwing into a mating thread of the second component. The bolt (20) has a recess (206) in which a spring lock washer (30) is inserted. As the bolt (20) is driven into the sleeve (10), the spring lock washer (30) is pressed radially into the recess (206). In the inserted state of the bolt, the spring lock washer (30) engages behind an inner shoulder (104) of the sleeve (10), so that the bolt (20) is axially supported positively in the sleeve (10) via the spring lock washer (30).

### BACKGROUND OF THE INVENTION

1. Technical Field

This application generally relates to an attachment device, and more specifically to an attachment device for attaching a first component to a second component.

2. Description of Related Art

During the assembly of an object, it is often necessary to attach or couple two or more components together. For example, plates, coverings, masks, or the like may be attached to a support structure. In attaching these types of device to a support structure, a sleeve can be inserted into a first component, such as the plate, covering, mask, or the like, as described above. The sleeve may penetrate the first component and may be axially secured to the component. A bolt whose front end projects out of the sleeve and has a thread with which the bolt is screwed into a mating thread of a second component, e.g., the support structure, is inserted into the sleeve. The bolt can rotate in the sleeve so it can be screwed in to the second component. The bolt supports itself axially on the sleeve in order to absorb the tensile forces with which the threads pull the components against one another.

The sleeve further includes support lugs, which project radially inward on its inner wall, on which the bolt supports itself with an outer shoulder when the bolt is driven axially into the sleeve, which sleeve is previously inserted in the first component. The sleeve has axial slits in the angular regions between the support lugs so that the shoulder of the bolt can be moved over the support lugs. In this way, the wall of the sleeve having the support lugs can yield radially outward as the shoulder of the bolt passes through and can snap back inward behind the shoulder. However, this sleeve includes several components that require relatively precise tolerances and as a result is costly to manufacture.

Therefore, there is a need for an attachment device that overcomes the limitations and drawbacks described above.

### SUMMARY OF THE INVENTION

The present invention sets forth an attachment device that can be employed to attach at least a first component to a second component, which attachment device can be produced relatively easily and economically.

In one aspect of the present invention, an attachment device is set forth that includes a bolt portion (hereinafter “bolt”) and a sleeve portion (hereinafter “sleeve”). The bolt is held in the sleeve using an elastic member, such as a spring lock washer, which is located in a recess of the bolt and can support itself axially on an inner shoulder of the sleeve. In one aspect, the elastic member can also include any one of the following: an elastic polymer ring, a spring steel split ring or a helical spring. As the bolt is introduced and driven into the sleeve, the spring lock washer is pressed radially into the recess, so that the bolt can slide into the sleeve. As soon as the spring lock washer has passed the inner shoulder of the sleeve, the spring lock washer expands radially outward and thus engages behind the inner shoulder of the sleeve. If the bolt moves axially backward as the components are separated, the bolt supports itself on the inner shoulder of the sleeve with the tip-side edge of the recess via the spring lock washer, so that the force of the bolt pushing the two components apart is positively supported axially on the sleeve.

The recess of the bolt preferably has two axial sections of different radial depths. A rear first axial section of the recess has a radial depth, which essentially corresponds with the radial thickness of the spring lock washer. As the bolt is driven into the sleeve, the spring lock washer can be compressed radially into this first section, so that it compresses into the peripheral contour of the bolt. The front second section, which adjoins the first section axially toward the tip of the bolt, has a lesser radial depth. This radial depth of the second section is dimensioned in such a way that the spring lock washer is expanded radially outward in the region of this second section far enough that it inevitably has to support itself on the inner shoulder of the sleeve and cannot be compressed radially to the inner circumference of this inner shoulder.

The sleeve preferably has two axial sections, a rear section with an inner diameter, which essentially corresponds to the outer diameter of the bolt and a front section that has a somewhat larger inner diameter. The radial inner shoulder of the sleeve forms the transition from the rear section with the smaller inner diameter to the front section with the larger inner diameter. This embodiment of the sleeve has, among other things, the advantage that the sleeve does not have any undercuts in the axial direction, so that the sleeve can be economically produced as a deep drawn part.

In an aspect of the present invention, the bolt can be produced as a blank, which is forged or cut off of a rod, and then turned on a lathe and provided with the recess and thread. The sleeve and the bolt can be produced from metal, with steel particularly suitable for being used to ensure high load carrying capacity of the connection.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 shows a side view of the attachment device, in which the sleeve and the spring lock washer are sectioned axially in accordance with one embodiment of the present invention;

FIG. 2 shows a top view of the spring lock washer of FIG. 1;

FIG. 3 shows an enlarged detail view of a driven-in position of the bolt of FIG. 1; and

FIG. 4 shows a view of a pulling position of the bolt of FIG. 3.

### DETAILED DESCRIPTION OF EMBODIMENT(S)

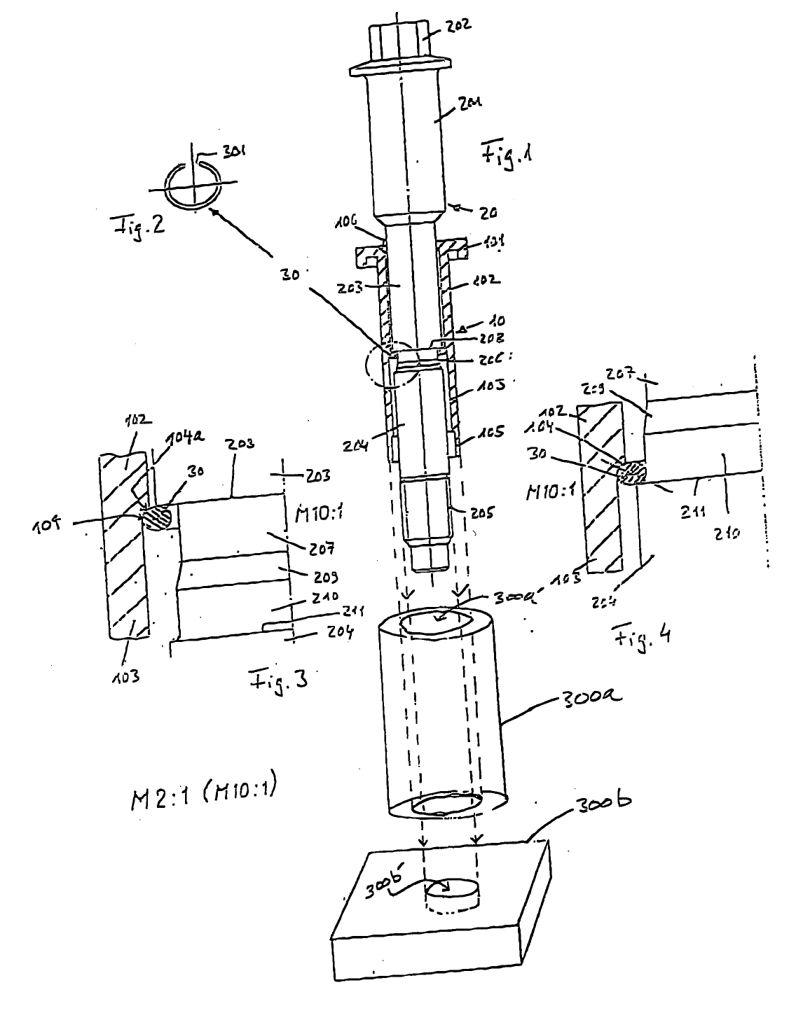

Referring to FIGS. 1-4, shown is an embodiment of the attachment device, which is used for attaching a first component 300a to a supporting second component 300b. The first and/or second components 300a and 300b can include a number of various shapes having a number of various dimensions, such as a plate, cylinder, block or the like. In one instance, the first component 300a can be a covering or mask, which is to be screwed onto the body of a motor vehicle that, for example, constitutes the second component 300b.

The attachment device includes a sleeve 10, a bolt 20, and a spring lock washer 30. The sleeve 10, the bolt 20, and the spring lock washer 30 are preferably made of steel. The sleeve 10 is inserted and fixed in the first component 300a. The bolt 20, along with the spring lock washer 30, can be positioned and driven into the sleeve 10. Thereafter, the bolt 20 can be rotated to couple the bolt 20, the sleeve 10 and first component 300a to the second component 300b.

In an embodiment, the sleeve 10 includes a cylindrically shaped tube with a constant outer diameter over its entire axial length. A rear end of the sleeve 10, which is shown as the upper end of the sleeve 10 in FIG. 1, includes a collar 101 that extends radially outward. The collar 101 may be formed by bending a portion of the sleeve 10 radially outward. A rear first section 102 of the sleeve 10, which extends over approximately half the axial length of the sleeve 10, has a first inner diameter. A second front section 103 of the sleeve 10, which adjacent to first section 102 of the sleeve, has a second inner diameter that is larger than the inner diameter of the first section 102 of the sleeve 10. The transition from the inner diameter of the first section 102 of the sleeve 10 to the larger inner diameter of the second section 103 of the sleeve 10 is formed by a radial inner shoulder 104. The radial inner shoulder 104 includes a stop plane 104 located perpendicular to the central axis of the sleeve 10. The inner shoulder 104 can include a number of various shapes having a number of various dimensions. For example, the inner shoulder 104 can include, a half sphere, a square step, a ramp or a notch.

An end section 105 of the sleeve 10 is located at the lower end of the sleeve 10 shown in FIG. 1. The end section 105 of the sleeve 10 includes an inner diameter that is greater than the inner diameter of the second section 103, so that the wall thickness of the sleeve 10 in this region of the end section 105 is relatively thin in comparison to the wall thickness of the sleeve 10 in the second section 103.

In an embodiment, the sleeve 10 can be inserted into the first component 300a. For this purpose, the first component 300a may have a through bore hole 300a′ whose inner diameter corresponds to the outer diameter of the sleeve 10. The material thickness of the first component 300a corresponds to the axial dimension of the sleeve 10 from a collar 101 up to the front end of the second section 103, where the second section 103 transitions into the end section 105. The sleeve 10 is driven into the through bore hole of the first component 300a until the collar 101 presses against a surface of the first component 300a. The end section 105 then projects out of the opposite surface of the component. The end section 105 may then be flanged outwardly, so that it presses against the surface of the first component 300a, which securely couples the sleeve 10 to the first component 300a. In one embodiment, the sleeve 10 does not have any undercuts in the axial direction so that sleeve 10 can be economically produced as a deep drawn part. Note that other techniques for attaching the sleeve 10 to the first component 300a may be used, such as welding, soldering, etc. and that other engagement members may be used to attach the sleeve 10 to the first component 300a.

A head 201 of the bolt 20, which located at the rear end of the sleeve 10, includes an engagement part 202. The engagement part 202 may be designed as a hexagon as illustrated in the exemplary embodiment, however, the engagement part 202 may just as well be designed as a hexagon socket, a cross recess, or the like. An adjoining head 201 includes a first shank section 203 whose outer diameter corresponds to the inner diameter of the first section 102 of the sleeve 10, with a slight radial play. The axial length of the first shank section 203 may also essentially correspond to the axial length of the first section 102 of the sleeve 10. A second shank section 204, whose outer diameter is somewhat reduced relative to the outer diameter of the first shank section 203, adjoins the first shank section 203 to the front. If the bolt 20 is completely inserted in the sleeve 10, the second shank section 204 projects axially forward, i.e., toward the bottom in the drawing, out of the sleeve 10. An external thread 205 is formed on the front end of the second shank section 204, which projects out of the sleeve 10. The external thread 205 corresponds to the internal thread of a bore hole 300b′, which is provided in the second component 300b

A recess 206, which is used to accommodate the spring lock washer 30, is provided at the transition from the first shank section 203 to the second shank section 204. The recess 206 has a deep rear section 207 which adjoins the first shank section 203. The outer circumference of the first shank section 203 changes into a deeper section 207 of the recess 206 with a stop shoulder 208, which is substantially perpendicular to the axis of the bolt 20. The radial depth of the deeper section 207 and therefore the radial width of the stop shoulder 208 corresponds to the radial material thickness of the spring lock washer 30. The deep section 207 of the recess 206 changes into a flat section 210 of the recess 206 in the direction of the second shank section 204 with a conically expanding transition section 209. The flat section 210 changes into a support shoulder 211 in the circumference of the second shank section 204. The support shoulder 211 forms a radial surface perpendicular to the axis of the bolt 20. The radial depth of the flat section 210 relative to the second shank section 204, and therefore the radial width of the support shoulder 211, corresponds to approximately half of the radial material thickness of the spring lock washer 30.

The spring lock washer 30 includes an axially slotted spring steel ring which has a circular material cross-section in the exemplary embodiment of the drawing. Alternatively, the spring lock washer 30 can also have an oval or flattened material cross-section stretched in the axial direction. The elastic property and the radial material thickness of the spring lock washer 30 determine operation thereof. The axial material dimension may be limited by the axial width of the sections 207 and 210 of the recess 206. The diameter of the spring lock washer 30 is dimensioned in such a way that the outer diameter of the unloaded spring lock washer 30 substantially corresponds to the inner diameter of the wider second section 103 of the sleeve 10. The inner diameter of the spring lock washer 30 and the width of axial slot 301 of the spring lock washer 30 are dimensioned in such a way that the spring lock washer 30 can be radially compressed enough in the deeper section 207 of the recess 206 that the outer circumference of the spring lock washer 30 lies inside the inner circumference of the first section 102 of the sleeve 10.

During assembly, the spring lock washer 30 is pushed from the front end toward the bolt 20 until the spring lock washer 30 is positioned in the recess 206. The reduced diameter of the second shank section 204 makes pushing on the spring lock washer 30 easier. The bolt 20 may then be introduced into the sleeve 10 from the rear end. Since the front second shank section 204 having the external thread 205 has a somewhat smaller outer diameter than the inner diameter of the first rear section 102 of the sleeve 10, the bolt 20 can be inserted easily until the spring lock washer 30 presses against the end of the sleeve 10. The bolt 20 is then driven into the sleeve 10 under axial pressure, with the spring lock washer 30 being radially compressed onto the inner diameter of the first section 102 of the sleeve 10. This compression of the spring lock washer 30 is made easier by a lead-in cone 106, which is implemented at the rear end of the sleeve 10, shown at the upper end in the drawing. The bolt 20 may be driven further into the sleeve 10, with a stop shoulder 208 of the deep section 207 of the recess 206 carrying along the spring lock washer 30 until the spring lock washer 30 passes the inner shoulder 104 of the sleeve 10. If the spring lock washer 30 has passed the inner shoulder 104. The spring lock washer 30 can thus expand radially, as shown in FIG. 3. The bolt 20 may now be held captively in the sleeve 10 and therefore in the first component 300a by the spring lock washer 30, which lies in the recess 206 and engages behind the inner shoulder 104.

If the first component 300a is attached to the second component 300b, the first component 300a is placed in such a way that the bolt 20 engages with the external thread 205 in the threaded bore hole 300b′ of the second component 300b. The bolt 20 may now be screwed with the external thread 205 into the threaded bore hole 300b′ of the second component 300b. At the same time, the bolt 20 moves axially forward in the sleeve 10 until the head 201 is stopped at the collar 101 of the sleeve 10. The head 201 may have a conical transition to the first shank section 203, which enters the feed cone 106. As the bolt 20 is screwed in further, the bolt 20 braces the first 300a and second 300b components. To disassemble the components, the bolt 20 may be screwed out of the threaded bore hole 300b′ of the second component 300b using the external thread 205 and moved back in sleeve 10, i.e., upward in the drawing.

Because the spring lock washer 30 is held axially by the inner shoulder 104 of the sleeve 10, the bolt 20 also moves axially relative to the spring lock washer 30. In this case, the bolt 20 moves from the deep section 207 into the spring lock washer 30 with the flat section 210 via the conical transition section 209. The conical transition section 209 causes the bolt 20 to slightly penetrate into the spring lock washer 30 at the same time. As soon as the bolt 20 has moved far enough axially into the sleeve 10, the spring lock washer 30 is seated on the flat section 210 of the recess 206 and the support shoulder 211 presses against the spring lock washer 30 so that the bolt 20 can move no further axially into the sleeve 10. The bolt 20 supports itself axially on the spring lock washer 30 with the support shoulder 211, which in turn supports itself axially on the inner shoulder 104. Since the flat section 210 has a lesser radial depth than the radial material thickness of the spring lock washer 30, the spring lock washer 30 can no longer yield inward and come free from the inner shoulder 104. The bolt 20 is thus axially supported positively on the sleeve 10. Upon further rotation of the bolt 20, the first component 300a is thus pressed away from the second component 300b by the thread, with the entire force of the bolt 20 being supported positively on the sleeve 10 via the spring lock washer 30.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A device that attaches a first component to a second component, comprising:
a sleeve positioned in the first component and being axially fixed in the first component; and
a bolt positioned in the sleeve, and having a threaded front end that projects outwardly from the sleeve for screwing into a mating thread of the second component, and which can be screwed into the sleeve with a slight radial play and held supported against axial forces,
wherein the bolt has a recess in its axial section accommodated in the sleeve and a spring lock washer located in the recess, whereby as the bolt is axially introduced into the sleeve, the spring lock washer is pressed radially by this sleeve into the recess and engages radially behind an inner shoulder of the sleeve for axial support.

2. The device according to claim 1, wherein the recess includes a rear deep section in a direction of introduction of the bolt and a front flat section adjoining the rear deep section; a radial depth of the rear deep section corresponding to a radial material thickness of the spring lock washer, and a radial depth of the flat section corresponding to approximately half of the radial material thickness of the spring lock washer.

3. The device according to claim 2, wherein the recess includes a stop shoulder formed on a rear end in the direction of introduction of the bolt and a support shoulder formed on a front end, the stop shoulder and the support shoulder each being located in a plane perpendicular to the axis of the bolt.

4. The device according to claim 3, wherein the sleeve has a rear first section in the direction of introduction of the bolt and an adjoining front second section; an inner diameter of the first section coinciding with an outer diameter of the bolt; an inner diameter of the second section being expanded relative to the inner diameter of the first section, and an inner shoulder of the sleeve is formed by a transition from the first section to the second section.

5. The device according to claim 4, wherein, at a rear end of the sleeve in the direction of introduction of the bolt, the sleeve includes a collar that projects radially outward, and an end section at a front end of the sleeve having a reduced wall thickness that can be flanged outward.

6. The device according to claim 5, wherein the bolt has a rear first shank section in the direction of introduction that includes an outer diameter coinciding with the inner diameter of the first section of the sleeve, and a front second shank section that is separated from the first shank section by the recess having an outer diameter that is reduced relative to the outer diameter of the first shank section.

7. The device according to claim 6, wherein the sleeve is a deep drawn part.

8. The device according to claim 7, wherein the sleeve, the bolt, and the spring lock washer are made of steel.

9. The device according to claim 8, wherein the spring lock washer includes an axial slot, an outer diameter of the spring lock washer in an unstressed state being equal to the inner diameter of the second section of the sleeve, and the material thickness of the spring lock washer and the width of the slot are dimensioned in such a way that the spring lock washer can be compressed to an outer diameter which is smaller than the inner diameter of the first section of the sleeve.

10. The device according to claim 1, wherein the recess includes a stop shoulder formed on a rear end in the direction of introduction of the bolt and a support shoulder formed on a front end, the stop shoulder and the support shoulder each being located in a plane perpendicular to the axis of the bolt.

11. The device according to claim 1, wherein the sleeve has a rear first section in the direction of introduction of the bolt and an adjoining front second section; an inner diameter of the first section coinciding with an outer diameter of the bolt; an inner diameter of the second section being expanded relative to the inner diameter of the first section, and an inner shoulder of the sleeve is formed by a transition from the first section to the second section.

12. The device according to claim 1, wherein, at a rear end of the sleeve in the direction of introduction of the bolt, the sleeve includes a collar that projects radially outward, and an end section at a front end of the sleeve having a reduced wall thickness that can be flanged outward.

13. The device according to claim 1, wherein the bolt has a rear first shank section in the direction of introduction that includes an outer diameter coinciding with the inner diameter of a first section of the sleeve, and a front second shank section that is separated from the first shank section by the recess having an outer diameter that is reduced relative to the outer diameter of the first shank section.

14. The device according to claim 1, wherein the sleeve is a deep drawn part.

15. The device according to claim 1, wherein the sleeve, the bolt, and the spring lock washer are made of steel.

16. The device according to claim 1, wherein the spring lock washer includes an axial slot, an outer diameter of the spring lock washer in an unstressed state being equal to an inner diameter of a second section of the sleeve, and a material thickness of the spring lock washer and a width of the slot being dimensioned to compress the spring lock washer to an outer diameter which is smaller than an inner diameter of a first section of the sleeve.

17. An attachment device, comprising:
a substantially cylindrical sleeve having a hollow interior portion with a first interior section, an adjacent second interior section, and an inner shoulder;
an elongated bolt that fits in the sleeve;
a recess formed on a portion of the bolt; and
an elastic member disposed in the recess, wherein the elastic member radially compresses inwardly in response to the bolt being disposed in the first interior section and wherein the elastic member radially decompresses outwardly to enable the elastic member to engage the inner shoulder in response to the bolt being disposed in the second interior section.

18. The attachment device of claim 17, wherein the inner shoulder is formed at a transition between the first interior section and the adjacent second interior section.

19. The attachment device of claim 17, wherein the sleeve further includes a collar formed on an end thereof to conformingly contact a first component.

20. The attachment device of claim 17, wherein a portion of the sleeve securely engages a portion of the first component.

21. The attachment device of claim 20, wherein the portion of the sleeve is constructed and arranged to expand outward in a radial direction to engage the first component.

22. The attachment device of claim 17, wherein the first interior section has a first interior diameter and the second interior section has a second interior diameter.

23. The attachment device of claim 22, wherein the first interior diameter is smaller than the second interior diameter.

24. The attachment device of claim 23, wherein the sleeve further includes a third portion having a third interior diameter greater than the second portion, the third portion being adjacent to the second portion.

25. The attachment device of claim 24, wherein the third portion extends into at least a portion of the first component.

26. The attachment device of claim 25, wherein the third portion is constructed and arranged to expand radially outward to securely attach the sleeve to the first component.

27. The attachment device of claim 17, wherein the bolt includes a stop shoulder and wherein the radial shoulder cooperates with the stop shoulder to apply approximately equal and oppositely directed forces on the elastic member to retain the bolt at the predetermined position.

28. The attachment device of claim 27, wherein the recess includes a rear deep section formed adjacent to the stop shoulder and a conically expanding section that tapers outwardly from the rear deep section to substantially match an outer diameter of the intermediate section of the bolt.

29. The attachment device of claim 17, wherein the bolt further includes an engagement head formed on an end thereof.

30. The attachment device of claim 17, wherein the bolt further includes an engagement member formed at an end thereof that releasably engages a first component coupled to a second component by the bolt.

31. The attachment device of claim 30, wherein the engagement member includes a threaded portion.

32. The attachment device of claim 17, wherein the elastic member includes any one of the members selected from the group consisting of: a spring lock washer, elastic polymer ring, spring steel split ring and a helical spring.

33. The attachment device of claim 17, wherein the sleeve is a deep drawn part.

34. The attachment device of claim 17, wherein the sleeve, the bolt, and the elastic member are made of steel.

35. An attachment device, comprising:
an elongated bolt;
means for accepting the elongated bolt;
an elastic member disposed on the bolt;
means for retaining the elastic member formed on the bolt;
means for engaging the elastic member, wherein the elastic member radially compresses in response to the bolt being disposed in a first interior section of the means for accepting the bolt and wherein the elastic member radially decompresses and is engaged in response to the bolt being disposed in a second interior section of the means for accepting the bolt.

36. The attachment device of claim 35, wherein the means for engaging the elastic member is formed at a transition between the first interior section and the second interior section.

37. The attachment device of claim 35, wherein the means for accepting the bolt further includes means for being securely engaged to a portion of a first component.

38. The attachment device of claim 37, wherein the bolt further includes means for releasably engaging a second component.

39. The attachment device of claim 35, wherein the means for accepting the bolt is a deep drawn part.
